(19) United States
(12) Patent Application Publication
(10) Pub. No.: US 2012/0218273 A1
(43) Pub. Date: Aug. 30, 2012

(54) DYNAMIC TYPESETTING METHOD OF DISPLAY IMAGE

(75) Inventors: Hong-Yang Tsai, Taipei (TW); Ko-Min Hsueh, Taipei (TW); Tzu-Teng Kao, Taipei (TW)

(73) Assignee: ESOBI INC., George Town (KY)

(21) Appl. No.: 13/402,705

(22) Filed: Feb. 22, 2012

(30) Foreign Application Priority Data
Feb. 25, 2011 (TW) 100106515

(51) Int. Cl. G06T 11/00

(52) U.S. Cl. 345/467

(57) ABSTRACT

A dynamic typesetting method of a display image includes the following steps obtaining a typeset-able area of a display image; calculating the size of the typeset-able area for applying a template having multiple display panes; calculating a page placement starting position of each display panes; according to the number of the display panes obtaining the data items corresponding to the number from a database; calculating a data weight of each of the data items, and sorting the data items and temporarily storing the data items in a temporary sequence according to values of the data weights; taking out the data items in the temporary storage sequence in sequence according to a typesetting order of the display panes, and placing the corresponding data items according to the page placement starting position of each display panes; and receiving a user operating instruction, and repeating actions in part of above steps accordingly.

### CROSS-REFERENCE TO RELATED APPLICATIONS

This non-provisional application claims priority under 35 U.S.C. §119(a) on Patent Application No(s). 100106515 filed in Taiwan, R.O.C. on Feb. 25, 2011, the entire contents of which are hereby incorporated by reference.

### BACKGROUND

1. Technical Field

The present disclosure relates to a dynamic typesetting method of a display image, and more particularly to a dynamic typesetting method of a display image that imitates a newspaper in dynamic typesetting and displays multiple data items on a display image.

2. Related Art

With the rapid development of the computers and Internet, the amount of information on the Internet increases dramatically. A user may obtain multifarious data from the Internet through a personal computer or various portable devices. For example, the user may subscribe to a channel by using Really Simple Syndication (RSS) to passively obtain real-time information, or actively store interesting data through a network for reading later.

Although the user may use a browser to read the information obtained through the network, currently developed automatic typesetting methods of reading interfaces vary in performance greatly, which often brings inconvenience to the user with respect to reading. For example, when a portable device, such as a mobile phone, is used to surf the network to browse a web page, the resolution required by an ordinary web page is greater than 1,024×768, which far exceeds the resolution of the screen of the mobile phone. Therefore, a display image on the screen can only display a very small part of web page contents, thereby decreasing readability.

Even though a large screen is used to browse information, the typesetting in the prior art mostly displays information in picture and text by listing, which appears to be inflexible and unsightly. Further, the information is provided unilaterally, which makes the reading interface of the user boring and unfriendly, and is likely to make the user loss interest and patience in reading.

### SUMMARY

The present disclosure is a dynamic typesetting method of a display image. According to the method, a page reading manner similar to that of a real newspaper is presented through a re-defined procedure of picture/text typesetting according to real-time news updated daily on the network or real-time updated information of a subscribed channel, so as to enable a user to browse a display image easily, increase affinity of the display image, and improve diversity of the page.

According to an embodiment, a dynamic typesetting method of a display image mainly includes the following steps:

(a) obtaining a typeset-able area of the display image;

(b) calculating the size of the typeset-able area, so as to apply a template having multiple display panes in the typeset-able area;

(c) calculating a page placement starting position of each of the display panes;

(d) according to the number of the display panes, obtaining the data items corresponding to the number from a database;

(e) calculating a data weight of each of the data items, and sorting the data items and temporarily storing the data items in a temporary sequence according to values of the data weights;

(f) taking out all of the data items in the temporary storage sequence in sequence, and placing the corresponding data items in the display panes according to the page placement starting position of each of the display panes; and

(g) receiving a user operating instruction, and repeating actions in Step (b) to Step (g).

The display panes of the template having the multiple display pane described in Step (b) is mainly a page of being a two-column type, or a three-column type, or a four-column type. That is, in the present disclosure, the templates having different page types are available, and may change dynamically according to the size of the typeset-able area of the display image or the user operating instruction. In some template types, rows are further disposed in a column, so that more data items may be placed therein. The replacement of the multiple types of the templates enables the user to browse the display image more conveniently.

Further, the typesetting order of the display panes (columns and rows) on the template is defined in advance. When the corresponding data items are placed in Step (f), the corresponding data items are placed in the display panes in sequence according to the typesetting order of the display panes.

Which template is to be applied is determined by calculating the number of pixels of a computer screen, and the page placement starting position of each of the display panes is calculated.

The data items in Step (d) refer to contents of information which is updated in real time and is from a channel to which a user subscribes through RSS, or contents of data stored by the user. The data items are stored in a database in a scattered manner.

The data item at least includes a title, a text, or a picture link. In Step (e), according to all contends (the title, the text and the picture link) included in each data item, an individual weight of each content may be calculated, and the data items are sorted according to the specific data weights of all of the data items.

For the data weight of the data item, a specific calculating formula thereof is shown below. An article weight may be log₁₀(the number of characters of the text×10). A picture weight may be log₁₀(\sqrt{the area of data picture}×the picture/document scale parameter). When the aspect ratio of the data picture is smaller than 0.75, the picture scale parameter of the data picture may be 0.5; when the aspect ratio is greater than or equal to 0.75, the picture scale parameter of the data picture may be 1. Further, when the article weight is greater than 5.5, the article weight may be adjusted to 5.5+(the original article weight−5.5)×0.2, so as to prevent the data weight from being too large when the number of the characters in the summary is too large.

In Step (f), the taking out all of the data items in the temporary storage sequence in sequence according to the typesetting order of the display panes in Step (c), and the placing the corresponding data item according to the page placement starting position of each of the display panes further include: calculating a picture display area, scaling a data picture according to the width and height of the corresponding data picture and the width and height of the corresponding display pane; and displaying the scaled data picture in the picture display area and trimming off a part exceeding the picture display area.

The receiving the user operating instruction in Step (g) refers to a functional instruction for controlling the display image, and refers to functional instructions for, such as, enlarging and shrinking in the preferred embodiment. When contents in the display image are enlarged or shrunken, the page placement starting position of each of the display panes in the template may change, so that a template meeting requirements of the function is required to be re-applied. Therefore, Step (b) is required to be returned to, so as to re-calculate the size of the typeset-able area and apply a suitable template. Then, actions in Step (c) to Step (g) are performed for replacement, so as to meet requirements of a user operating function and achieve a display state of the data.

According to another embodiment, when the user operating instruction relates to deleting an obtained data item, it is only required that another data item is obtained from the database to fill the display pane, and the size of the typeset-able area is not required to be re-calculated, so that the loop returns to the actions in Step (d) to Step (g) to re-calculate the data weights of all of the data items and perform sorting, and the data items are reset according to an order of the display panes of the template, so as to meet requirements of the user operating instruction.

In view of the above, in the dynamic typesetting method of the display image provided by the present disclosure, a suitable template may be applied in a typeset-able area, and the presentation manner of pictures and texts in the typeset-able area may be re-defined through display panes in the template. By dividing the display fields and re-typesetting the data items, the typesetting manner of a newspaper may be imitated. Further, in the present disclosure, after user operating instructions are received, the typesetting manner of the page is dynamically adjusted according to the user operating instructions, so as to display an image meeting requirements of the user operating instructions, thereby providing the user with reading experience being vivid, enriched with images, and full of fun.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic block diagram of a dynamic typesetting method of a display image according to a first embodiment;

FIG. 2A to FIG. 2E are schematic views of templates;

FIG. 3A to FIG. 3B are schematic views of picture display areas;

FIG. 4A to FIG. 4C are schematic views of display results;

FIG. 5 is a schematic block diagram of a dynamic typesetting method of a display image according to a second embodiment; and

FIG. 6 is a schematic flow chart of a dynamic typesetting method of a display image.

### DETAILED DESCRIPTION

The present disclosure provides a dynamic typesetting method of a display image, so as to dynamically typeset and display multiple data items on a display image. The method may obtain, through a network, data items, such as news, which have pictures and texts and are updated in real time, and re-typeset the obtained pictures and texts, so as to present a page reading manner similar to that of a real newspaper, which is in conformity to reading habits of the user.

The dynamic typesetting method of a display image may be executed in any computer that can be connected to the network or has at least one built-in database, for example, a personal computer, a notebook computer, a server or a portable device (also called a mobile device) such as a mobile phone. A display image obtained through the method may be displayed to the user through a screen of a computer, and interact with the user in real time during the reading.

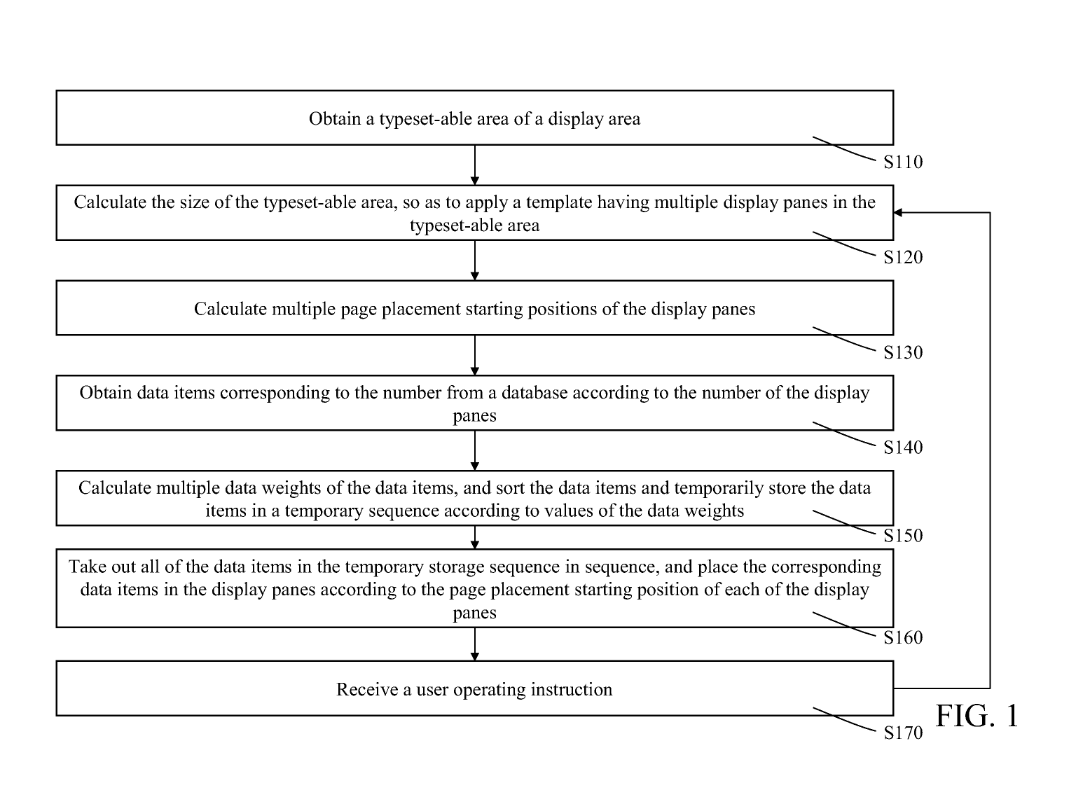

FIG. 1 is a schematic block diagram of a dynamic typesetting method of a display image according to a first embodiment.

First, a typeset-able area of a display image is obtained (Step S110). The typeset-able area is a display image of a whole screen excluding a title bar, a toolbar, and a status bar which cannot be used for displaying contents. A computer calculates the size of the typeset-able area, so as to apply a template having multiple display panes in the typeset-able area (Step S120). For example, the size of the whole display image is 1,024 pixels×560 pixels, and the typeset-able area therein is 960 pixels×400 pixels.

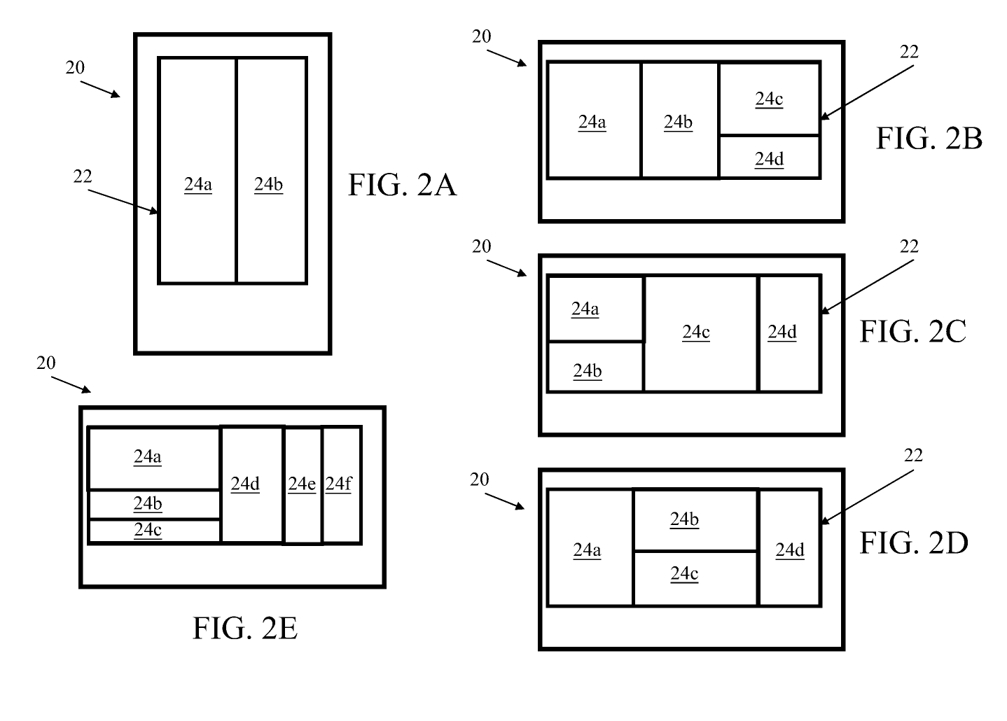

In the present disclosure, which template is to be applied in Step S120 is determined by calculating the number of pixels of the screen. FIG. 2A to FIG. 2E are schematic views of different templates.

In Step S120, the number of fields may be calculated first according to a typeset-able area 22 of a display image 20 and a preset field width, then a suitable template is selected according to the number of fields, and the selected template is applied in the typeset-able area 22. The preset field width is used to estimate the suitable number of fields. For example, when the number of fields is estimated, it may be assumed that each column displays the same number of characters, and the preset field width may correspond to a font size (which represents the number of pixels occupied by a Chinese character or an English letter) for display. Therefore, the greater the currently set font size, the greater the corresponding preset field width. The method does not limit a correlation between the font size and the preset field width, and the correlation may be implemented through a table.

For example, the preset field width corresponding to the font size of 10 is 220 pixels, and the preset field width corresponding to the font size of 14 is 308 pixels. Therefore, when the currently set font size is 14, and the width of the typeset-able area 22 is 960 pixels, the width of the typeset-able area 22 may be divided by the corresponding preset field width of 308 pixels, that is, 960/308≈3.11. Therefore, the calculated suitable number of fields is 3.

The number of fields may be, for example, 2, 3, or 4, so that display panes 24a to 24f of the templates may be a two-column type, or a three-column type, or a four-column type. Further, the column in the template may further be divided into multiple rows, so that a column has more display panes 24a to 24f for placing data items. For example, the template in FIG. 2A is the two-column type, the templates in FIG. 2B to FIG. 2D are the three-column type, and the template in FIG. 2E is the four-column type. It can be seen from the drawings that the method does not limit the division of the template. In FIG. 2B to FIG. 2D all being the three-column type, the width of the column, the number of rows in the column, and the height of the row may all be modified according to actual needs. If the obtained number of fields corresponds to multiple templates, one of the templates may be selected in sequence or randomly, and applied in the typeset-able area 22.

In addition, the template may also be selected according to the shape of the typeset-able area 22. For example, when the typeset-able area 22 is a vertical rectangle, a template of the two-column type is often employed, and when the typeset-able area 22 is a horizontal rectangle of 16:9, a template of the four-column type may be employed.

After the template is applied, multiple page placement starting positions of the display panes 24a to 24f in the template are calculated respectively (Step S130). The template in FIG. 2B is used as an example below to illustrate a calculation method in Step S130.

The template in FIG. 2B has display panes 24a, 24b, 24c and 24d, and is typeset into a two-column-two-row page. According to an embodiment, the vertex at the upper left corner of the whole typeset-able area 22 may be set as the origin of two-dimensional coordinates, and position information, including the page placement starting position and size, of each of the display panes 24a to 24d is recorded in scale values.

By using a recording format (a horizontal page placement starting position, a vertical page placement starting position, the width, the height) as an example, the position information of the display pane 24a is (0, 0, 0.3, 1), and the position information of the display pane 24b is (0.3, 0, 0.35, 1). In order to obtain actual coordinates of the display panes 24a to 24d, only a product of the size of the typeset-able area 22 and the corresponding scale value is required to be obtained. For example, for the display pane 24a, the coordinates of the vertex at the upper left corner is (0, 0), and the coordinates of the vertex at the lower right corner is (288, 400).

After the template to be applied and the number of the display panes 24a to 24d included by the template are determined in Step S130, the number of data items to be obtained may be determined, and data items corresponding to the number are obtained from a database according to the number of the display panes 24a to 24d (Step S140). The data items may be contents of information which is updated in real time and is from a channel to which a user subscribes through RSS, or may be contents of data stored by the user. The data items are stored in the database in a scattered manner, and may be classified respectively according to the type or date of the contents. For example, the data item may be a piece of news, a note, an advertisement, or a piece of real-time information received through the RSS.

The data item at least includes a title, a text, and a picture link. Each picture link corresponds to a data picture. The text of the data item may be, for example, a piece of news, a note, an advertisement, or a summary of real-time information. For a data item having multiple picture links, at least one picture link may be selected randomly to download a corresponding data picture for display; alternatively, a picture filtering procedure may be executed in Step S140 to remove data pictures not suitable for typesetting. For example, the picture filtering procedure may filter out a data picture with the width and the height both being smaller than 75 pixels or both being greater than 1,280 pixels, and may also filter out a data picture with an aspect ratio being smaller than 0.5 or greater than 2.5.

For a data item having a summary having less than 100 characters, a pure word processing procedure may be executed, so as to obtain an original web page content or an original picture corresponding to the data item. The obtained original web page content or original picture may be provided for the user to read, and the picture filtering procedure may be executed for the original picture obtained through the pure word processing procedure.

After suitable data items are obtained, data weights of the data items are calculated, and the data items are sorted and temporarily stored in a temporary sequence according to values of the data weights (Step S150). In Step S150, according to all contends (the title, the text and the picture link) included in each data item, an individual weight of each content may be calculated, and the data items are sorted in size according to the specific data weights of all of the data items. However, in Step S150, the data weight may be obtained by obtaining a sum or a product of the weights.

For example, for a data item having a title or a text, the sum of the total numbers of characters may be obtained, and an article weight of the data weight is log₁₀(the number of characters of the text×10). For example, for a data item having a picture link, a picture weight, being log₁₀(\sqrt{the area of data picture}×the picture/document scale parameter), of the data weight thereof may be calculated. When the aspect ratio of the data picture is smaller than 0.75, the picture scale parameter of the data picture may be 0.5; when the aspect ratio is greater than or equal to 0.75, the picture scale parameter of the data picture may be 1. Further, when an article weight is greater than 5.5, in Step S150, the article weight may be adjusted to 5.5+(the original article weight−5.5)×0.2, so as to prevent the data weight from being too large when the number of the characters in the summary is too large.

It is assumed that for the display pane 24a, the total number of characters of the corresponding data item is 250, and the size of the corresponding data picture is 320×240, so that it may be calculated that a picture/document scale is 1.33, and a picture/document scale parameter is 1. Further, it is assumed that the data weight is the article weight plus the picture weight, so that the data weight of the data item corresponding to the display pane 24a is log₁₀(250×10)+log₁₀(\sqrt{320×240}×1)=3.39+2.44=5.83.

In this way, all data weights may be calculated, all of the data items in the temporary storage sequence are taken out in sequence, and the corresponding data items are placed in the display panes 24a to 24d according to the page placement starting position of each of the display panes 24a to 24d (Step S160).

Details of the execution of Step S160 are as follows. First, all of the data items in the temporary storage sequence are taken out in a descending order of size according to a typesetting order of the display panes 24a to 24d. The typesetting order may be a result of sorting all of the display panes 24a to 24d according to the area of each of the display panes 24a to 24d. In other words, matching may be performed according to the typesetting order of the display panes 24a to 24d and the values of the data weights, so that the data item having a great data weight (that is, the data item being important) is distributed to one of the leading panes among the display panes 24a to 24d. In this way, when the data items are less than the display panes, the beauty resulting from the typesetting is not affected.

Further, the display panes 24a to 24d (columns and rows) on the template are different in size, a size order thereof (that is, the typesetting order) may be that distribution is performed from left to right. The biggest display pane 24a is the leftmost one in the page, and the display pane 2d is the rightmost one in the page. When the corresponding data items are placed in Step S160, the typesetting order thereof is determined according to the size of the display panes 24a to 24d, and the corresponding data items are placed in the display panes 24a to 24d from left to right.

For the display panes 24a to 24d corresponding to data items having picture links, a picture display area of each of the display panes 24a to 24d is calculated, and the data pictures are scaled according to the width and height of the data pictures corresponding to the picture links and the width and height of the corresponding display panes 24a to 24d.

If the display panes 24a to 24d are vertical rectangles (for example, the display panes 24a and 24b), the picture display area may be configured in a top middle position. The size of the picture display area may be calculated according to the aspect ratio and width of the corresponding display panes 24a and 24b. If the display panes 24a to 24d are horizontal rectangles (for example, the display panes 24c and 24d), the picture display area may be configured in an upper left position to imitate a typesetting manner of a newspaper. The size of the picture display area may be calculated according to the aspect ratio and height of the corresponding display panes 24c and 24d.

Before a data picture is scaled, a horizontal direction scaling ratio, being a result of the width of the data picture divided by the width of the picture display area, and a vertical direction scaling ratio, being a result of the height of the data picture divided by the height of the picture display area, may be calculated first. If the horizontal and vertical direction scaling ratios are both smaller than 1, it indicates that the picture is required to be enlarged, so that the data picture is enlarged according to a larger one among the horizontal direction scaling ratio and the vertical direction scaling ratio. However, in order to prevent over-enlarging from deteriorating image quality, it may be limited that the result is at most 1.5 times of the original after enlarging. Otherwise, the data picture may be shrunken according a smaller one among the horizontal direction scaling ratio and the vertical direction scaling ratio in combination with the picture display area.

The scaled data picture is displayed in the picture display area, and a part thereof exceeding the picture display area is trimmed off. For example, if the aspect ratio of the picture display area is greater than 1, the aspect ratio of the data picture is smaller than 0.9, and the vertical direction scaling ratio multiplied by 0.6 is still greater than the horizontal direction scaling ratio, it indicates that the display panes 24a to 24d are horizontal rectangles but the data picture is the vertical rectangle, only 60% of the image, being the upper middle part of the data picture, may be displayed, and the rest is trimmed off.

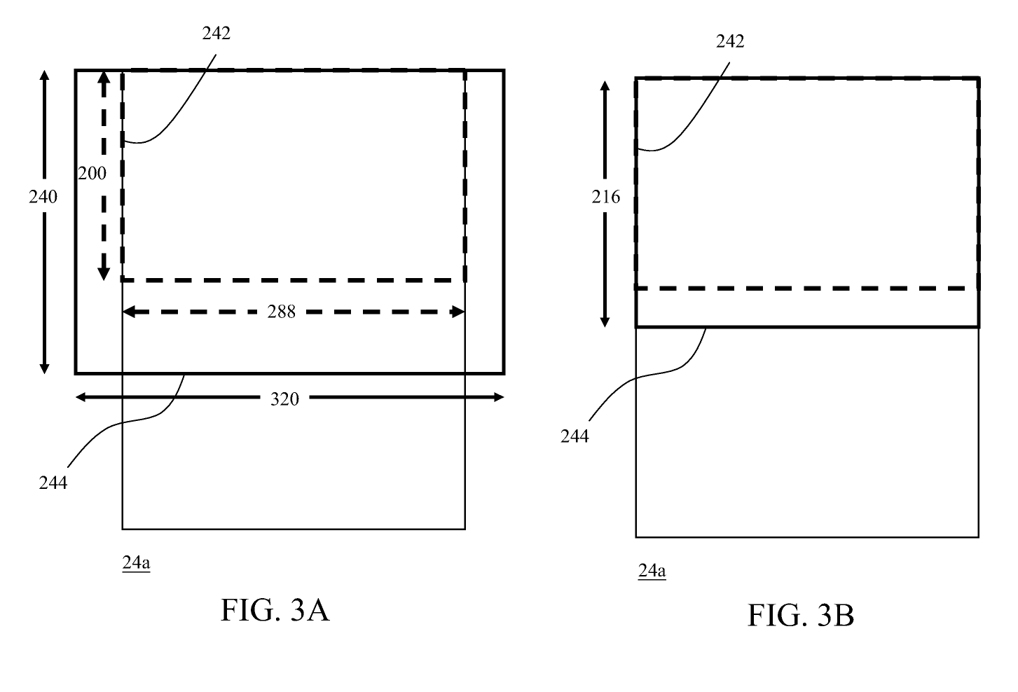

Referring to FIG. 3A and FIG. 3B, FIG. 3A and FIG. 3B are schematic views of picture display areas.

In view of the above example, it is assumed that a picture display area 242 corresponding to the display pane 24a is 288×200, and the horizontal and vertical direction scaling ratios of a corresponding data picture 244 are 1.11 and 1.2 respectively, as shown in FIG. 3A. Therefore, the data picture 244 is shrunken to a picture with the size being (320/1.2)×(240/1.1)=288×216 (as shown in FIG. 3B), a lower part of 288×16 pixels of the shrunken data picture 244 is trimmed off, and the trimmed data picture 244 is placed in the picture display area 242.

Finally, the title or text of the data item is place in a position which is within the display panes 24a to 24d and is outside the picture display area 242, so that all of the data items may be placed in correct corresponding positions according to actual positions of all of the display panes 24a to 24d.

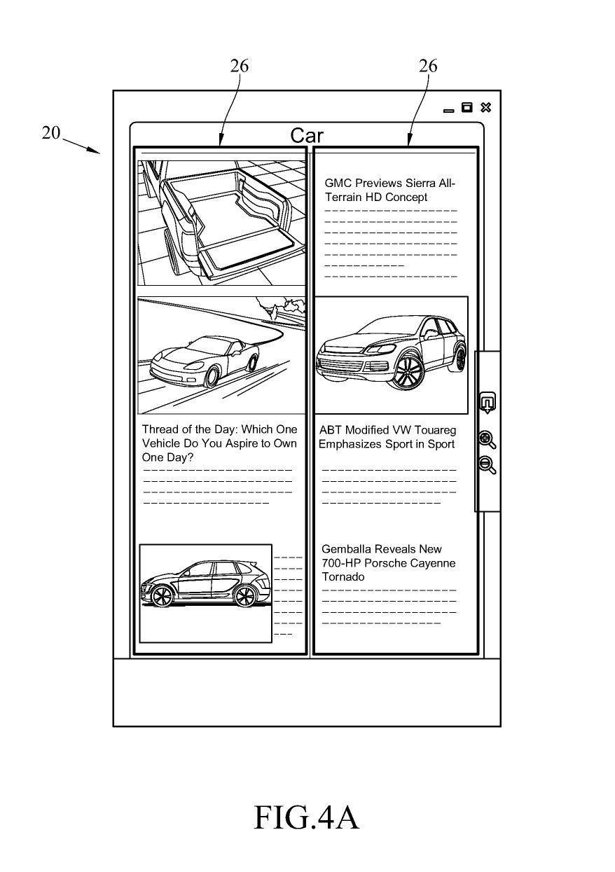

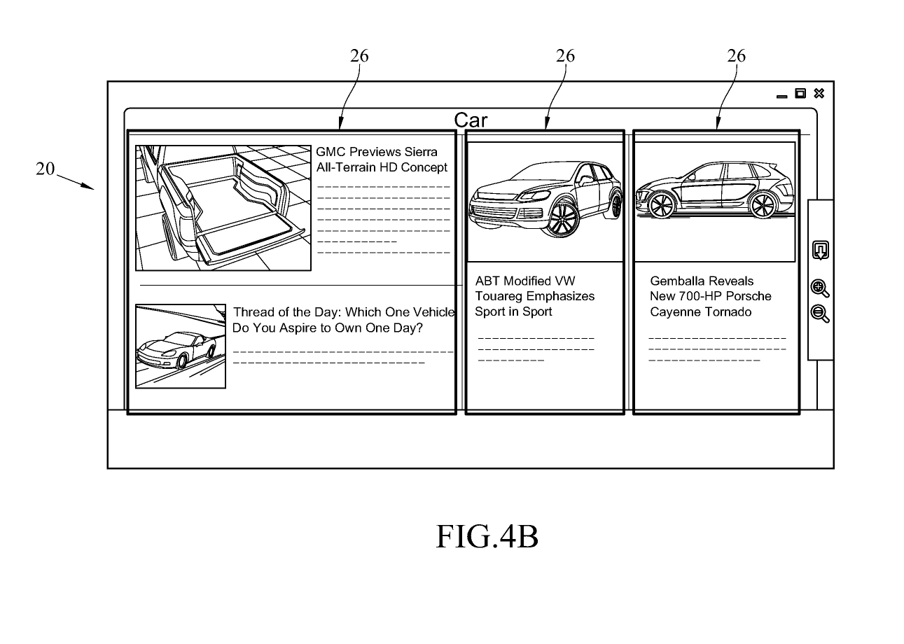

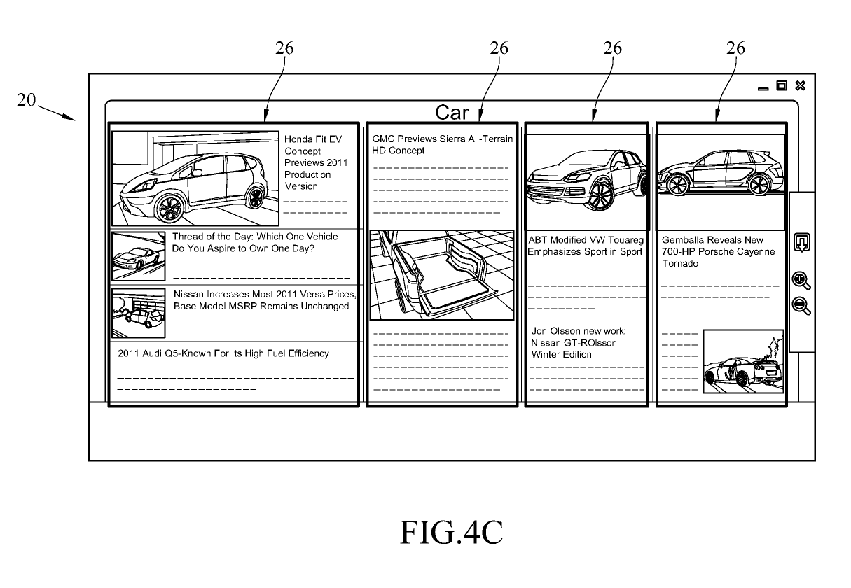

Referring to FIG. 4A, FIG. 4B and FIG. 4C, FIG. 4A, FIG. 4B and FIG. 4C are schematic views of different display results respectively. The templates in the FIG. 4A, FIG. 4B and FIG. 4C are the two-column type, the three-column type and the four-column type respectively, where a column 26 is further horizontally cut into multiple display panes. It can be seen that the result obtained by typesetting according to Step S110 to Step S160 is formed by pictures and texts as news, so that the method may provide the user with reading experience being vivid, enriched with images, and full of fun.

After the typeset data items are displayed to the user, the method may further receive a user operating instruction (Step S170), and actions in Step (b) to Step (g) may be repeated. Specifically, the user operating instruction may be a shrinking instruction or an enlarging instruction. The method dynamically applies a corresponding template according to the user operating instruction, and displays the data items in the corresponding template. An instruction for enlarging or shrinking displayed contents may affect the font size for display, so that when Step S120 is returned to, the suitable number of fields and the template may be affected. If the scaling causes the template to change, the page placement starting positions of the display panes are required to be re-calculated in the following, and then the data items are placed accordingly, so as to meet requirements of a user operating function and achieve a display state of the data items.

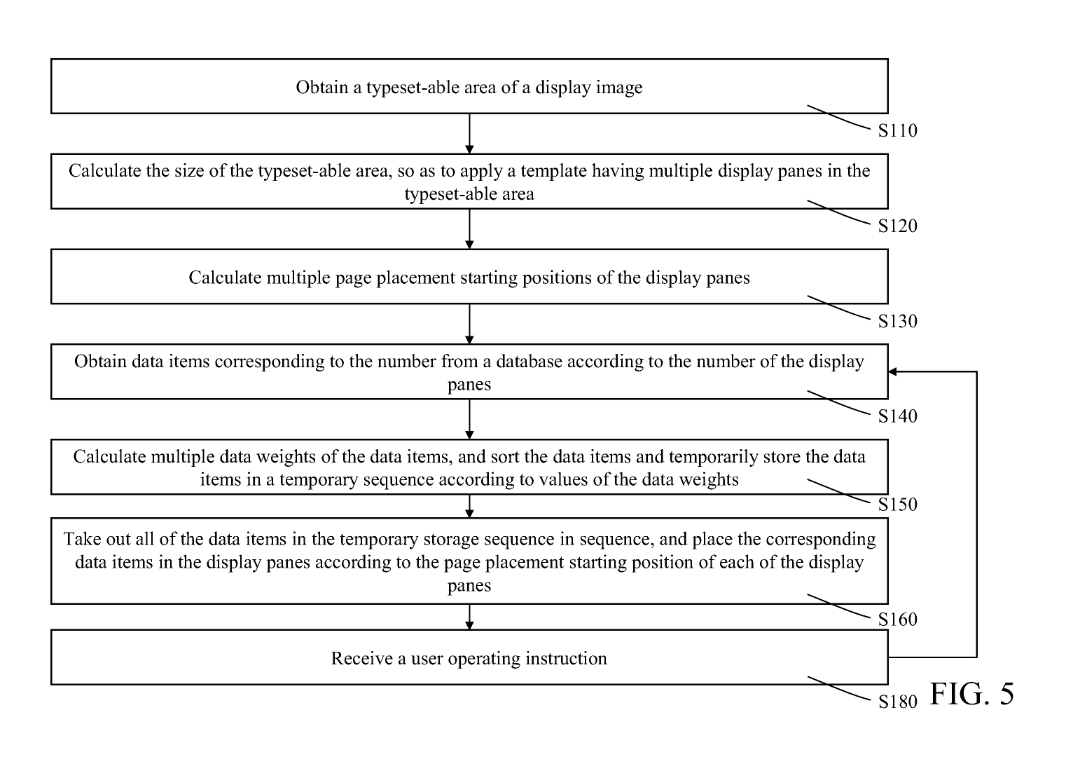

According to another embodiment, the user operating instruction may be a deletion instruction for deleting one of displayed data items. Referring to FIG. 5, FIG. 5 is a schematic block diagram of a dynamic typesetting method of a display image according to a second embodiment. If the user expects to read other data item with the current layout being kept, a deletion instruction may be used to delete at least one of the currently displayed data items. The instruction does not cause the template to change, so that after the deletion instruction used as the user operating instruction is received (Step S180), it is only required that Step S140 is returned to, at least one new data item is obtained to take the place of the deleted data item, and the data weights of all of the data items are re-calculated, which are re-sorted and displayed.

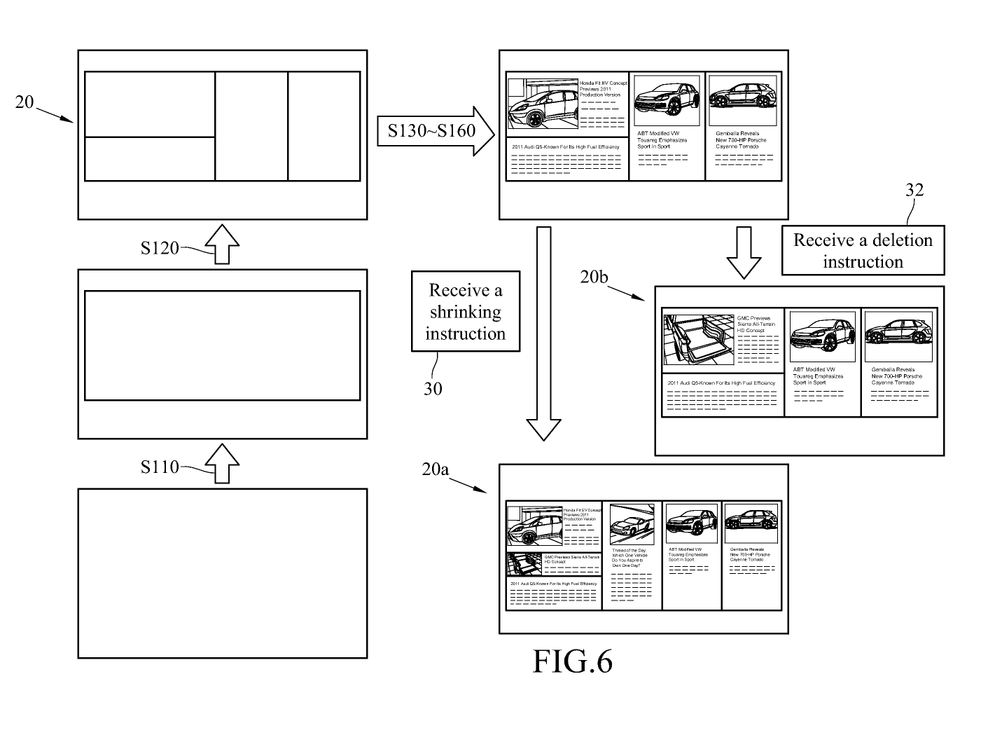

Referring to FIG. 6, FIG. 6 is a schematic flow chart of a dynamic typesetting method of a display image. A three-column type template is applied in a display image 20 in Step S110 and Step S120. Four data items are displayed in the three-column type template in Step S130 to Step S160. By receiving a shrinking instruction 30, the method may dynamically re-select a new template, and re-typesetting is performed according to the number of display panes of the template and the data items, which are then provided for the user, as shown by a display image 20a. By receiving a deletion instruction 32, the method may dynamically delete and add a data item, which is then provided for the user, as shown by a display image 20b.

In view of the above, in the method, presence of data items in a typeset-able area is defined by dividing display panes, so that the user can read the data items on a computer screen as on a newspaper. According to the present disclosure, multiple different templates may be prepared in advance, and may be dynamically changed according to the size of the typeset-able area or a user operating instruction, so that the user may read multiple news items more conveniently and easily.

What is claimed is:

1. A dynamic typesetting method of a display image, for dynamically typesetting and displaying multiple data items on a display image, the dynamic typesetting method of the display image comprising:
(a) obtaining a typeset-able area of the display image;
(b) calculating the size of the typeset-able area, so as to apply a template having multiple display panes in the typeset-able area;
(c) calculating a page placement starting position of each of the display panes;
(d) according to the number of the display panes, obtaining the data items corresponding to the number from at least one database;
(e) calculating a data weight of each of the data items, and sorting the data items and temporarily storing the data items in a temporary sequence according to values of the data weights;
(f) taking out all of the data items in the temporary storage sequence in sequence, and placing the corresponding data items in the display panes according to the page placement starting position of each of the display panes; and
(g) receiving a user operating instruction, and repeating actions in Step (b) to Step (g).

2. The dynamic typesetting method of the display image according to claim 1, wherein the display panes comprised by the template are presented in a page being a two-column type, or a three-column type, or a four-column type.

3. The dynamic typesetting method of the display image according to claim 1, wherein in Step (b) and Step (c), the applied template is selected by calculating the number of pixels, the page placement starting position of each of the display panes of the template is calculated, and Step (b) comprises:
calculating the number of fields according to the typeset-able area and a preset field width; and
selecting the template according to the number of fields, and applying the template in the typeset-able area.

4. The dynamic typesetting method of the display image according to claim 1, wherein Step (d) comprises:
executing a picture filtering procedure for the data item having multiple picture links; and
executing a pure word processing procedure for a summary having less than 100 characters, so as to obtain an original web page content or an original picture corresponding to the data item.

5. The dynamic typesetting method of the display image according to claim 1, wherein the data items in the database are information which is updated in real time and is from at least one channel subscribed to through Really Simple Syndication (RSS).

6. The dynamic typesetting method of the display image according to claim 1, wherein the data items each at least comprises a title, a text, or a picture link, the picture link corresponds to a data picture; in Step (e), the corresponding data weight is calculated according to the title, the text or the picture link, and sorting is performed according to values of the data weights of the data items;
a picture weight of the data weight is log₁₀(\sqrt{the area of data picture}×the picture/document scale parameter); when an aspect ratio of the data picture is smaller than 0.75, a picture scale parameter of the data picture is 0.5; when the aspect ratio is greater than or equal to 0.75, the picture scale parameter of the data picture is 1; and
an article weight of the data weight is log₁₀(the number of characters of the text×10), when the article weight is greater than 5.5, in Step (e), the article weight is adjusted to 5.5+(the original article weight−5.5)×0.2.

7. The dynamic typesetting method of the display image according to claim 1, wherein Step (f) comprises:
according to a typesetting order of the display panes, taking out all of the data items in the temporary storage sequence in sequence;
for the display pane corresponding to the data item having a picture link, calculating a picture display area of the display pane, and scaling the data picture according to the width and height of a data picture corresponding to the picture link and the width and height of the corresponding display pane;
displaying the scaled data picture in the picture display area, and trimming off a part exceeding the picture display area; and
according to the page placement starting position, placing a title or a text of each of the data items in a position which is within the corresponding display pane and is outside the picture display area.

8. The dynamic typesetting method of the display image according to claim 1, wherein the user operating instruction is a shrinking instruction or an enlarging instruction, so that according to the user operating instruction, the corresponding template is applied, and the data items are displayed in the corresponding template.

9. A dynamic typesetting method of a display image, for dynamically typesetting and displaying multiple data items on a display image, the dynamic typesetting method of the display image comprising:
(a) obtaining a typeset-able area of the display image;
(b) calculating the size of the typeset-able area, so as to apply a template having multiple display panes in the typeset-able area;
(c) calculating a page placement starting position of each of the display panes;
(d) according to the number of the display panes, obtaining the data items corresponding to the number from at least one database;
(e) calculating a data weight of each of the data items, and sorting the data items and temporarily storing the data items in a temporary sequence according to values of the data weights;
(f) taking out all of the data items in the temporary storage sequence in sequence, and placing the corresponding data items according to the page placement starting position of each of the display panes; and
(g) receiving a user operating instruction, and repeating actions in Step (d) to Step (g).

10. The dynamic typesetting method of the display image according to claim 9, wherein the display panes comprised by the template are presented in a page being a two-column type, or a three-column type, or a four-column type.

11. The dynamic typesetting method of the display image according to claim 9, wherein in Step (b) and Step (c), the applied template is selected by calculating the number of pixels, the page placement starting position of each of the display panes of the template is calculated, and Step (b) comprises:
calculating the number of fields according to the typeset-able area and a preset field width; and
selecting the template according to the number of fields, and applying the template in the typeset-able area.

12. The dynamic typesetting method of the display image according to claim 9, wherein Step (d) comprises:
executing a picture filtering procedure for the data item having multiple picture links; and
executing a pure word processing procedure for the data item having a summary having less than 100 characters, so as to obtain an original web page content or an original picture corresponding to the data item.

13. The dynamic typesetting method of the display image according to claim 9, wherein the data items in the database are information which is updated in real time and is from at least one channel subscribed to through Really Simple Syndication (RSS).

14. The dynamic typesetting method of the display image according to claim 9, wherein the data items each at least comprises a title, a text, or a picture link, the picture link corresponds to a data picture; in Step (e), the corresponding data weight is calculated according to the title, the text or the picture link, and sorting is performed according to values of the data weights of the data items;
a picture weight of the data weight is log₁₀(\sqrt{the area of data picture}×the picture/document scale parameter); when an aspect ratio of the data picture is smaller than 0.75, a picture scale parameter of the data picture is 0.5; when the aspect ratio is greater than or equal to 0.75, the picture scale parameter of the data picture is 1; and
an article weight of the data weight is log₁₀(the number of characters of the text×10), when the article weight is greater than 5.5, in Step (e), the article weight is adjusted to 5.5+(the original article weight−5.5)×0.2.

15. The dynamic typesetting method of the display image according to claim 9, wherein Step (f) comprises:
according to a typesetting order of the display panes, taking out all of the data items in the temporary storage sequence in sequence;
for the display pane corresponding to the data item having a picture link, calculating a picture display area of the display pane, and scaling the data picture according to the width and height of a data picture corresponding to the picture link and the width and height of the corresponding display pane;
displaying the scaled data picture in the picture display area, and trimming off a part exceeding the picture display area; and
according to the page placement starting position, placing a title or a text of each of the data items in a position which is within the corresponding display pane and is outside the picture display area.

16. The dynamic typesetting method of the display image according to claim 9, wherein the user operating instruction is a deletion instruction for deleting one of the displayed data items, so that a new data item is obtained to take the place of the deleted data item, and the data weights of all of the data items are re-calculated, which are re-sorted and displayed.
